(19) United States
(12) Patent Application Publication
(10) Pub. No.: US 2008/0297009 A1
(43) Pub. Date: Dec. 4, 2008

(54) STATOR MEMBER AND MOTOR

(75) Inventors: Masaki YOKOYAMA, Nagano (JP); Shinichi UTSUMI, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/130,485

(22) Filed: May 30, 2008

(30) Foreign Application Priority Data
May 31, 2007 (JP) JP2007-146058

(51) Int. Cl. H02K 37/14

(52) U.S. Cl. 310/49 R

(57) ABSTRACT

A stator member may include a coil bobbin provided with a through-hole and around which a coil is wound, and a yoke provided with a fixing part that is inserted into the through-hole of the coil bobbin. The through-hole of the coil bobbin is provided with at least a recessed part at a position corresponding to a burr of the fixing part of the yoke. Another stator member may include a first yoke provided with a fixing plate at a side end portion of the first yoke, and a second yoke provided with a fixing hole into which the fixing plate is inserted. The first yoke and the second yoke are disposed to face each other and a recessed part is formed on the fixing hole of the second yoke at a position corresponding to a burr formed on the fixing plate.

### CROSS REFERENCE TO RELATED APPLICATION

The present invention claims priority under 35 U.S.C. §119 to Japanese Application No. 2007-146058 filed May 31, 2007, which is incorporated herein by reference.

### FIELD OF THE INVENTION

An embodiment of the present invention may relate to a stator member and a motor. More specifically, an embodiment of the present invention may relate to a stator member in which a coil wound around a coil bobbin is assembled into a yoke, and relate to a motor in which a rotor is disposed on an inner side of the stator member.

### BACKGROUND OF THE INVENTION

A PM type (Permanent Magnet Type) stepping motor in which a permanent magnet is used in a rotor has been conventionally known. For example, as shown in FIG. 11, a stepping motor 100 has been known in which coils 106 are respectively disposed so as to surround an outer periphery of a plurality of pole teeth 104 which are formed to be bent from an inner circumferential edge of stator cores 102. In the stepping motor 100 as described above, an entire size of the stepping motor 100 is determined by a diameter of the coil 106 and thus, in order to secure a predetermined winding number of a coil to obtain a rotational torque, reduction of the size and width of the motor is limited.

On the other hand, a stepping motor whose width is made thinner has been known (see, for example, Japanese Patent Laid-Open No. Hei 1-99466), in which a pair of rectangular coils is disposed on both sides of pole teeth that are formed bent from an inner periphery of the stator cores.

A flat type stepping motor 200 as described above is, as shown in FIG. 12, provided with stator members 212, each of which includes a yoke 206, which is formed with a plurality of pole teeth 202 formed on its inner circumferential edge and with fixing plates 204 formed so as to face the pole teeth 202, another yoke 208 which is formed with pole teeth 202 that are adjacently disposed to the pole teeth 202 of the yoke 206, and coils 210 into which the fixing plates 204 are inserted and which are fixed between the yoke 206 and the yoke 208. A rotor 216 in which a magnet (not shown) is integrally provided in a rotor shaft 214 is rotatably supported on an inner side of the pole teeth 202 of the stator members 212 through a bearing.

In the stepping motor 200 structured as described above, a rotation drive force is applied to the rotor 216 by interaction between a magnetic field generated by an electric current flowing through the coil 210 and the magnet and rotation is outputted from one end side of the rotor shaft.

A coil bobbin used in the above-mentioned stator member is formed with a through-hole and the coil bobbin is fixed to one of the yokes through the fixing plate which is inserted into the through-hole. Further, the other of the yokes is fixed to the one yoke by utilizing a fixing method such that a tip end of the fixing plate of the one yoke is welded to the other yoke.

Therefore, in order to prevent rattling between the yokes or rattling between the yoke and the coil bobbin, the fixing plate of the yoke is often lightly press-fitted into the through-hole of the coil bobbin and an engaging part of the other yoke. Therefore, a cross-sectional shape of the fixing plate and cross-sectional shapes of the through-hole and the engaging part are designed so that there is substantially no clearance therebetween.

However, when tolerances of the yokes, the coil and other component parts are taken into consideration, in a case that the clearance is too small, a burr of the fixing plate or the like may be caught by end faces of the through-hole and/or the engaging part and thus the fixing plate is not inserted into the through-hole and/or the engaging part. Alternatively, a large force is required for inserting the fixing plate into the through-hole and/or the engaging part and thus deformation of the members may occur. On the other hand, in a case that the clearance is too large, rattling occurs between the yokes or between the yoke and the coil bobbin and thus the pole teeth of one yoke may contact with those of the other yoke, or displacement may occur in a positional relationship between the pole teeth and the coil.

These malfunctions cause assembling work of a stator member to remarkably deteriorate and its product yield is decreased.

### SUMMARY OF THE INVENTION

In view of the problems described above, at least an embodiment of the present invention may advantageously provide a stator member in which assembling of a yoke to a coil bobbin can be smoothly performed and whose assembling workability is satisfactory, and may advantageously provide a motor which is provided with the stator member.

Thus, according to an embodiment of the present invention, there may be provided a stator member including a coil bobbin provided with a through-hole and around which a coil is wound, and a yoke provided with a fixing part which is inserted into the through-hole of the coil bobbin. The through-hole of the coil bobbin is provided with at least a recessed part at a position corresponding to a burr of the fixing part of the yoke. According to the structure as described above, when the fixing part is to be inserted into the through-hole of the coil bobbin, the burr of the fixing part is not caught by an opening edge portion or an inner peripheral face of the through-hole and thus the fixing part can be smoothly inserted into the through-hole. Therefore, assembling workability of the stator member is improved. Further, the fixing part is not required to be forcibly inserted into the through-hole and thus a large force is not carelessly applied. Therefore, reduction of yield of the stator member can be prevented.

Further, according to another embodiment of the present invention, there may be provided a stator member including a first yoke provided with a fixing plate at a side end portion of the first yoke, and a second yoke provided with a fixing hole into which the fixing plate is inserted. The first yoke and the second yoke are disposed to face each other and a recessed part is formed on the fixing hole of the second yoke at a position corresponding to a burr formed on the fixing plate. According to the structure as described above, when the fixing plate of the first yoke is to be inserted into the fixing hole of the second yoke, the burr of the fixing plate is not caught by an opening edge portion or an inner peripheral face of the fixing hole and thus the fixing plate can be smoothly inserted into the fixing hole. Therefore, assembling workability of the stator member is improved. Further, the fixing plate is not required to be forcibly inserted into the fixing hole and thus a large force is not carelessly applied to the first yoke and the second yoke. Therefore, reduction of yield of the stator member can be prevented.

In this case, it is preferable that the stator member includes a coil bobbin provided with a through-hole into which the fixing plate is inserted, and that a recessed part is formed on the through-hole of the coil bobbin at a position corresponding to a burr formed on the fixing plate. According to this structure, a recessed part is formed at a position corresponding to a portion such as a burr of the fixing plate which is protruded from an end face and is easily caught. Therefore, when the fixing plate is to be inserted into the through-hole of the coil bobbin and the fixing hole of the second yoke, the burr of the fixing plate is not caught by an opening edge portion and an inner peripheral face of the through-hole and the fixing hole and thus the fixing plate can be smoothly inserted into the through-hole and the fixing hole. Therefore, assembling workability of the stator member is improved. Further, the fixing plate is not required to be forcibly inserted into the through-hole and the fixing hole and thus a large force is not carelessly applied. Therefore, reduction of yield can be prevented.

In this case, it is preferable that the recessed part is formed on an inner peripheral face of the through-hole and/or the fixing hole in a concave shape so as to avoid the burr formed on the fixing plate. The burr of the fixing plate is formed to protrude from its end face. Therefore, when the recessed part is formed in a concave shape, the burr of the fixing plate is not caught by the inner peripheral face of the through-hole and/or the fixing hole effectively when the fixing plate is inserted into the through-hole and/or the fixing hole.

Further, it is preferable that the through-hole and/or the fixing hole are formed in a quadrangular shape and the recessed part is formed at a corner part of the quadrangular shape. When the cross-sectional shape of the fixing plate is in a quadrangular shape, the burr is often formed at its corner part. Therefore, according to this structure, the edge portion and/or the inner peripheral face of the through-hole and/or the fixing hole can effectively avoid the burr of the fixing plate.

In accordance with an embodiment, the through-hole and/or the fixing hole are formed in a rectangular shape and the recessed part is formed in a longitudinal direction of the rectangular shape. When the cross-sectional shape of the fixing plate is rectangular, the fixing plate is often formed so as to be pushed out in a longitudinal direction when separated from a molding die in a method of injection-molded working. In this case, the burr may be formed in the longitudinal direction but, according to this structure, the edge portion and/or the inner peripheral face of the through-hole and/or the fixing hole can effectively avoid the burr of the fixing plate.

In accordance with an embodiment, the inner peripheral face of the through-hole and/or the fixing hole is formed with abutting parts which abut with a surface of the fixing part in all directions corresponding to the quadrangular shape. According to this structure, the through-hole and/or the fixing hole are fixed to the fixing plate by the abutting parts without displacement. Therefore, the coil bobbin and/or the second yoke are firmly fixed to the fixing plate without rattling. As a result, the performance of the stator member becomes stable and its yield can be improved.

In accordance with an embodiment, the fixing plate is inserted into the through-hole and/or the fixing hole by press fitting. According to this structure, the through-hole of the coil bobbin and/or the fixing hole of the second yoke can be fixed to the fixing plate of the first yoke without rattling and thus the performance of the stator member becomes stable and its yield can be improved. In this case, it is preferable that the through-hole and/or the fixing hole are formed in a quadrangular shape and the recessed part is formed at a corner part of the quadrangular shape, and an abutting area when the fixing plate of the yoke is inserted into the through-hole and/or the fixing hole is reduced by the recessed part. Specifically, it is preferable that the inner peripheral face of the through-hole and/or the fixing hole is formed with abutting parts which abut with a surface of the fixing plate in all directions corresponding to the quadrangular shape, and a required press fitting force is adjusted by the recessed part when the fixing plate of the yoke is inserted.

Further, according to an embodiment of the present invention, there may be provided a motor in which a stator member is disposed on an outer side of a rotor magnet which is attached to a rotor shaft. The stator member includes a yoke provided with a pole part facing the rotor magnet and with a fixing part for a coil, and a coil bobbin which is provided with a through-hole into which the fixing part is inserted and around which the coil is wound, and the through-hole of the coil bobbin is provided with at least a recessed part at a position corresponding to a burr of the fixing part of the yoke. According to this structure, a recessed part is formed at a position corresponding to a burr of the fixing part which is protruded from an end face to be easily caught. Therefore, when the fixing part is to be inserted into the through-hole of the coil bobbin, the burr of the fixing part is not caught by an opening edge portion or an inner peripheral face of the through-hole and thus the fixing part can be smoothly inserted into the through-hole. Therefore, assembling workability of the stator member is improved. Further, the fixing part is not required to be forcibly inserted into the through-hole and thus a large force is not carelessly applied. Therefore, reduction of yield of the stator member can be prevented.

Further, according to another embodiment of the present invention, there may be provided a motor in which the above-mentioned stator member is disposed on an outer side of the rotor magnet which is attached to a rotor shaft. According to this structure, a recessed part is formed at a position corresponding to a portion such as a burr of the fixing plate which is protruded from an end face to be easily caught. Therefore, when the fixing plate is to be inserted into the fixing hole of the second yoke, the burr of the fixing plate is not caught by an opening edge portion and an inner peripheral face of the fixing hole and thus the fixing plate can be smoothly inserted into the fixing hole. Therefore, assembling workability of the stator member is improved. Further, the fixing plate is not required to be forcibly inserted into the fixing hole and thus a large force is not carelessly applied. Therefore, reduction of yield can be prevented.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an exploded perspective view showing a structure of a stator member in accordance with an embodiment of the present invention.

FIG. 2 is a plan view showing a fixing plate of a connecting part of a first yoke which is viewed from an upper side.

FIG. 3 is an enlarged cross-sectional view showing a through-hole of a coil bobbin into which a fixing plate has been inserted.

FIG. 4 is a perspective view showing the stator member shown in FIG. 1 in which pole-teeth parts of a second yoke are assembled into a first yoke.

FIG. 5 is a top plan view showing a state where the fixing plate has been inserted into a fixing hole of the pole-teeth part shown in FIG. 3.

FIG. 6 is a perspective view showing a state where the stator member shown in FIG. 1 has been assembled.

FIGS. 7(a), 7(b) and 7(c) are enlarged cross-sectional views showing modified examples of recessed parts which are formed on a through-hole and/or a fixing hole.

FIG. 8 is a top plan view showing a state where projecting parts are inserted into fixing holes of a joining part of the second yoke.

FIG. 9 is an exploded perspective view showing a structure of a motor in accordance with an embodiment of the present invention.

FIG. 10 is a perspective view showing a state where the motor shown in FIG. 9 has been assembled.

FIG. 11 is a partially cross-sectional perspective view showing a conventional stepping motor.

FIG. 12 is a perspective view showing a conventional flat type stepping motor.

### DETAILED DESCRIPTION OF THE PREFERRED EMBODIMENTS

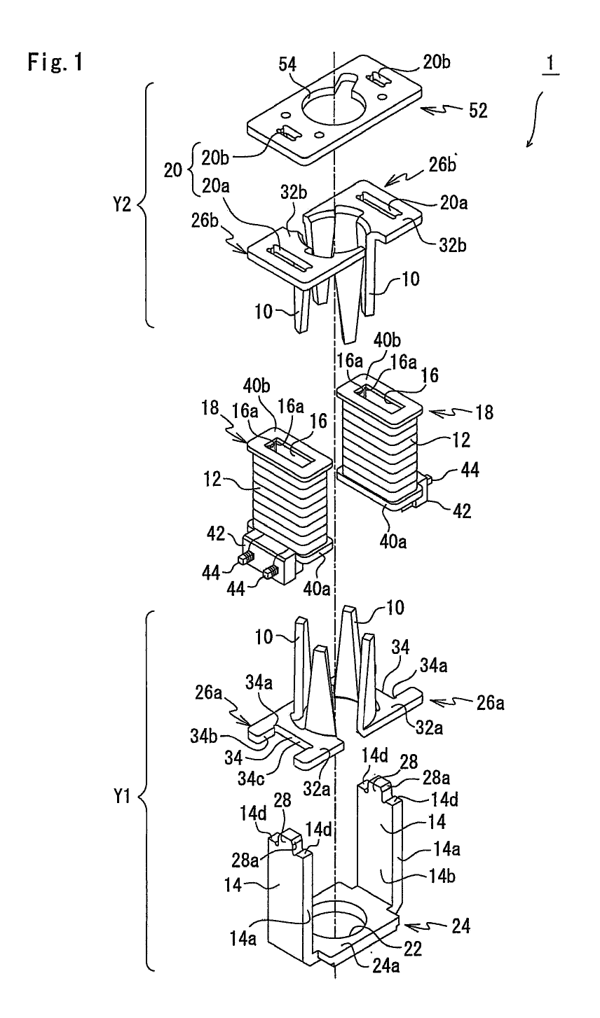

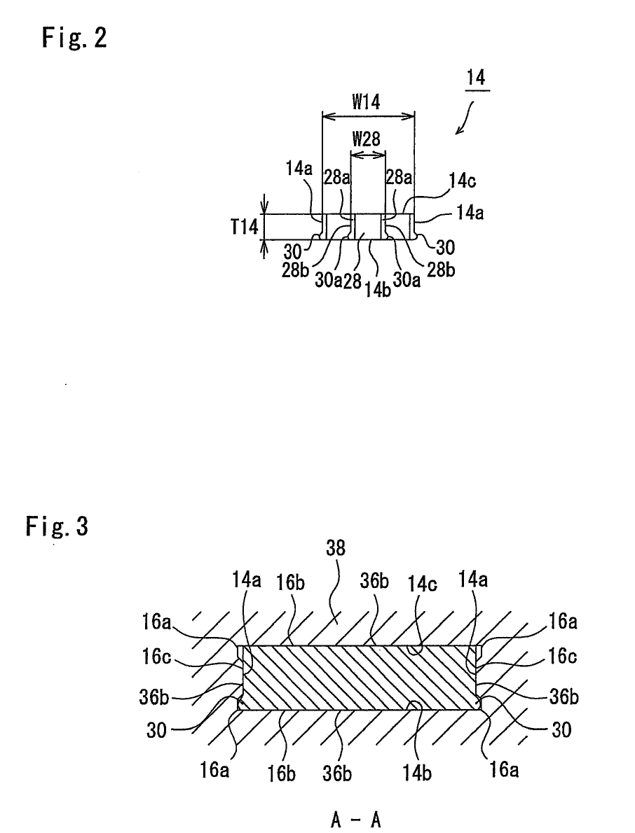

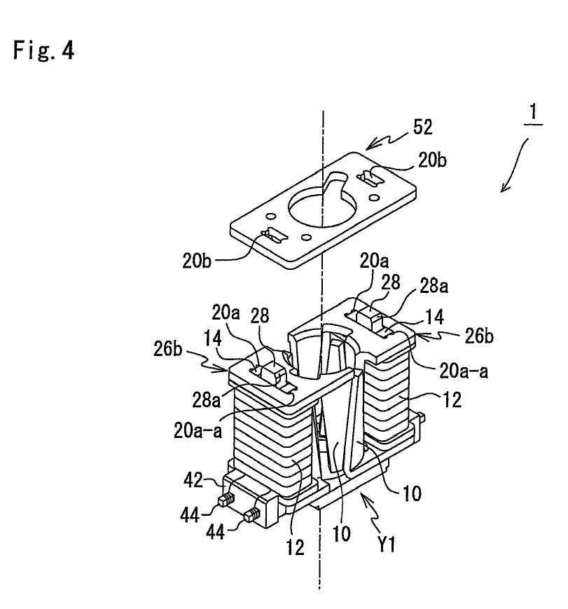

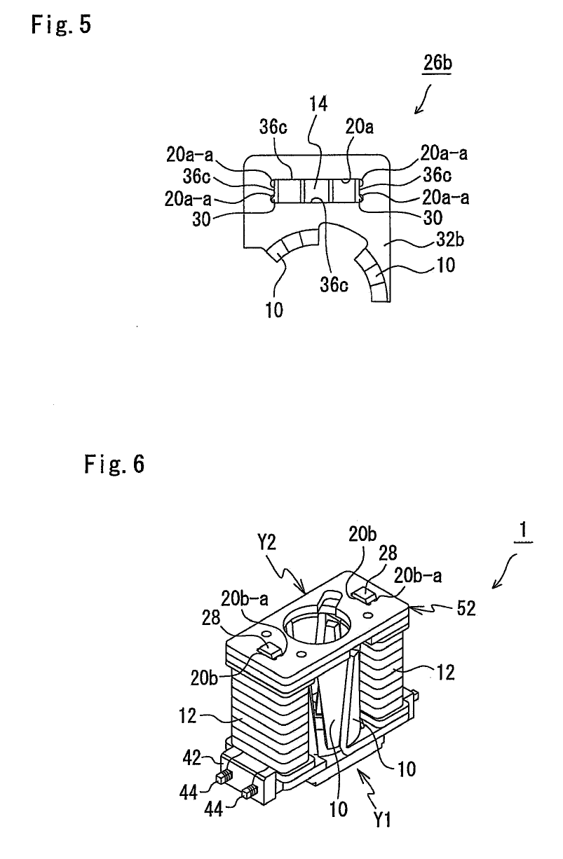

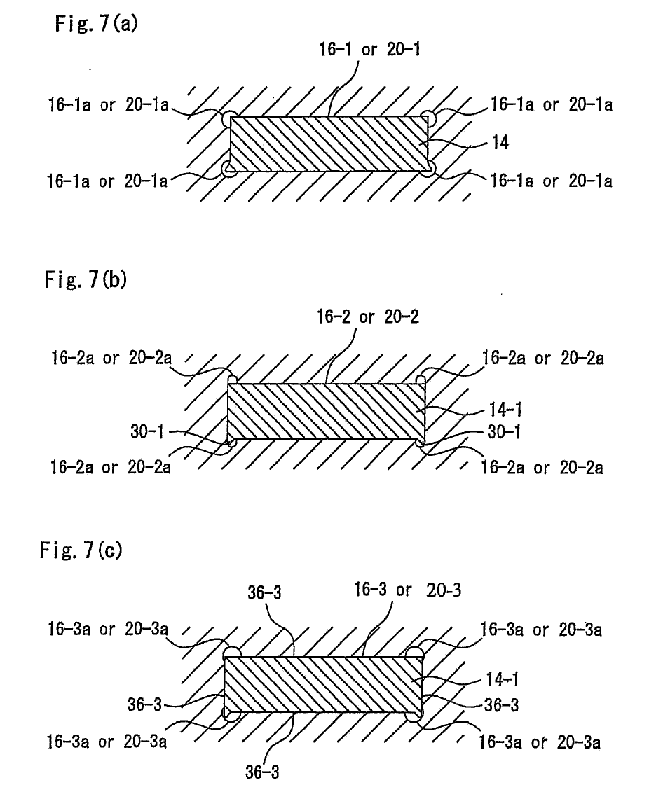

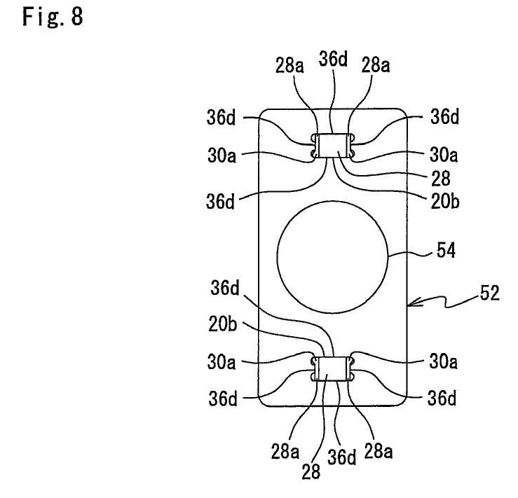

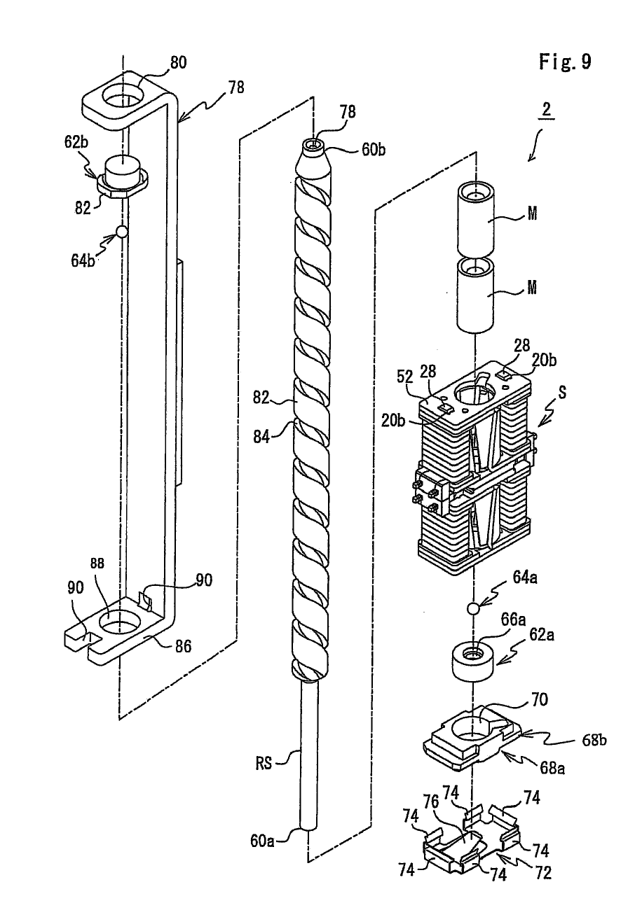

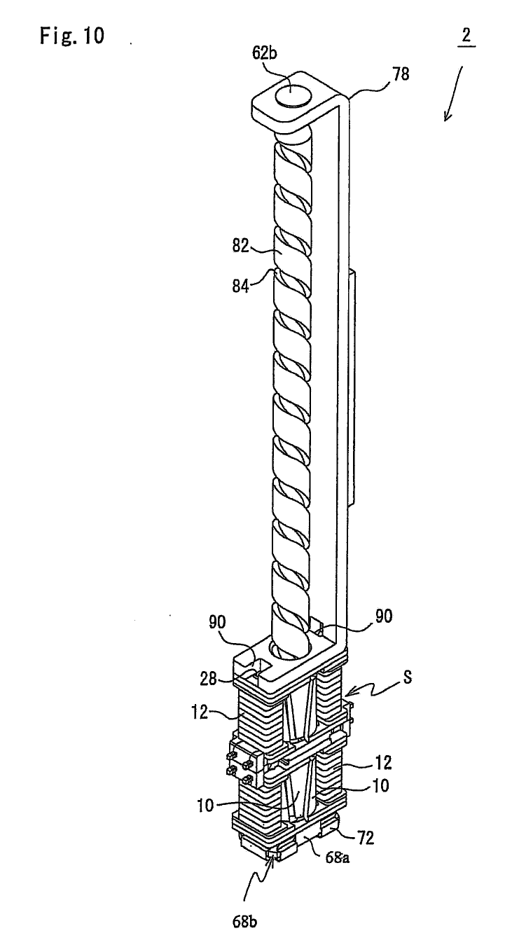

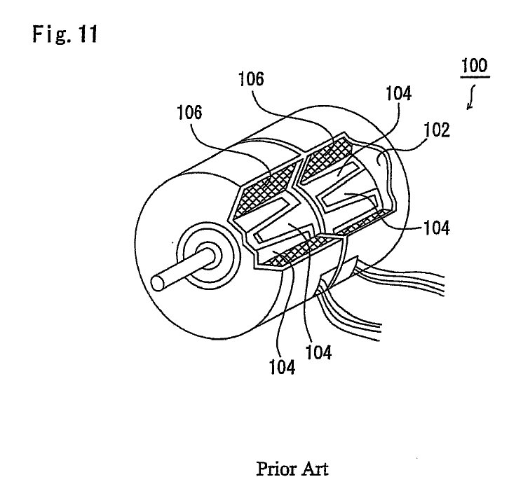

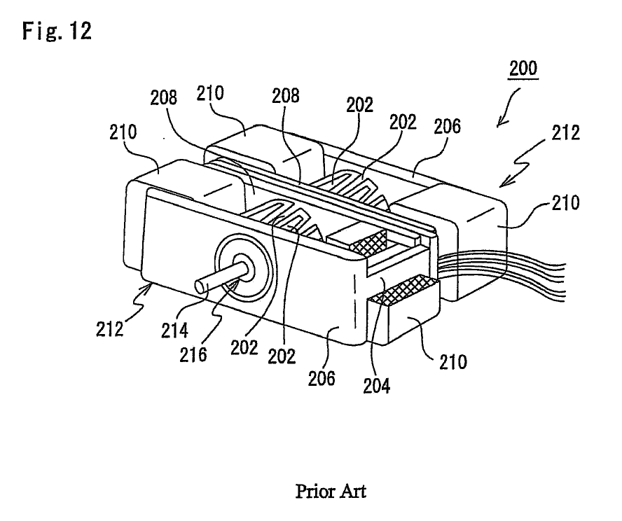

A stator member 1 and a motor 2 in accordance with an embodiment of the present invention will be described in detail below with reference to the accompanying drawings. FIG. 1 is an exploded perspective view showing a structure of a stator member in accordance with an embodiment of the present invention. FIG. 2 is a plan view showing a fixing plate of a connecting part of a first yoke which is viewed from an upper side. FIG. 3 is an enlarged cross-sectional view showing a through-hole of a coil bobbin into which a fixing plate has been inserted. FIG. 4 is a perspective view showing the stator member shown in FIG. 1 in which pole-teeth parts of a second yoke have been assembled into a first yoke. FIG. 5 is a top plan view showing a state where the fixing plate has been inserted into a fixing hole of the pole-teeth part shown in FIG. 3. FIG. 6 is a perspective view showing the stator member shown in FIG. 1 which has been assembled. FIGS. 7(a), 7(b) and 7(c) are enlarged cross-sectional views showing modified examples of recessed parts which are formed in a through-hole and/or a fixing hole. FIG. 8 is a top plan view showing a state where projecting parts have been inserted into fixing holes of a joining part of the second yoke. FIG. 9 is an exploded perspective view showing a structure of a motor in accordance with an embodiment of the present invention. FIG. 10 is a perspective view showing a state where the motor shown in FIG. 9 has been assembled. A stator member 1 in accordance with an embodiment of the present invention is disposed on outer sides of a rotor magnet M which is attached to a rotor shaft RS to structure a motor 2.

As shown in FIG. 1, the stator member 1 includes a first yoke Y1, coil bobbins 18 around which a coil 12 is respectively wound and a second yoke Y2. In the first yoke Y1, a plurality of pole teeth 10 where a magnetic pole of N-pole or S-pole is generated by supplying an electric current to the coils 12 is standingly formed on its inner circumferential edge and fixing plates 14 which is a fixing part where the coil 12 is mounted are standingly formed on outer sides of the pole teeth 10. The coil bobbin 18 is provided with a through-hole 16 into which the fixing plate 14 of the first yoke Y1 is inserted. The second yoke Y2 includes a plurality of pole teeth 10 which are standingly formed so as to be adjacently disposed to the pole teeth 10 of the first yoke Y1 and fixing holes 20 to which the fixing plates 14 of the first yoke Y1 are inserted. In this stator member 1, the first yoke Y1 and the second yoke Y2 are assembled into a yoke.

The first yoke Y1 is comprised of a connecting part 24 provided with a bottom plate 24a and a pair of pole-teeth parts 26a. The bottom plate 24a of the connecting part 24 is formed with an opening 22 for magnet through which a rotor magnet M is passed and the fixing plates 14 are standingly formed on both sides of the bottom plate 24a. Each of the pole-teeth parts 26a is standingly formed with a plurality of the pole teeth 10 along a peripheral edge of the opening 22 for magnet. The first yoke Y1 is formed of a magnetic steel plate such as iron which is press-worked. In this embodiment, the fixing plates 14 are standingly formed from the connecting part 24. However, the fixing plates 14 may be formed as separate members beforehand and fixed to the connecting part 24 by a method such as adhesion and welding.

The connecting part 24 is formed with the opening 22 for magnet at a center of the bottom plate 24a formed in a roughly rectangular shape and the strip-shaped fixing plates 14 are extended from side edge portions of the bottom plate 24a so as to face each other. A pair of the fixing plates 14 are bent at a substantially right angle with respect to the bottom plate 24a so as to face each other. In this embodiment, the fixing parts 14 are integrally formed with the bottom plate 24 but the fixing parts 14 may be formed as separate members in advance. In this case, for example, projecting parts may be formed on both ends of the fixing plate 14 which is formed as a separate member and a fixing hole 20 is formed in the connecting part 24 and then, the projecting part of the fixing plate 14 is inserted and fixed to the fixing hole 20 formed in the connecting part 24.

FIG. 2 is an enlarged plan view showing the fixing plate 14 of the connecting part 24 which is viewed from an upper side. In the stator member 1, a burr 30 which is protruded from the plate thickness T14 is formed on an end face 14a of the connecting part 24 by press working when the connecting part 24 is punched. In addition, the burr 30 which is protruded from the plate thickness T14 is deformed by press working for bending the fixing plates 14 from the both sides of the bottom plate 24a and a burr 30 protruding in a face direction of the fixing plate 14 is formed. In other words, the burr 30 is formed so as to protrude in the same direction as a long side of the fixing plate 14 having a substantially rectangular cross section from both ends of the long side. In FIG. 2, the burr 30 is formed on both sides of one face 14b of the fixing plate 14 but the burr 30 may be formed partially. As described above, the burr in the fixing plate 14 may be formed on the cutting faces 14a and 28a of the fixing plate 14.

As shown in FIG. 1, a base portion 32a for connecting the respective pole teeth 10 is disposed on a base end side of a plurality of the pole teeth 10 which is standingly formed along the peripheral edge of the aperture 22 for magnet of the connecting part 24. A cut-out part 34 to which the fixing plate 14 of the connecting part 24 is fitted is formed in an outer side portion of the base portion 32a and the fixing plate 14 is fitted to the cut-out part 34.

The cut-out part 34 has substantially the same cross-sectional shape as that of the fixing plate 14. As shown in FIG. 2, the fixing plate 14 is formed in a substantially rectangular cross section and thus the cut-out part 34 is formed so that one side of the pole-teeth part 26a is cut out in a substantially rectangular shape. A width of the cut-out part 34 is set to have substantially the same dimension as a width W14 of the fixing plate 14. A width of the fixing hole 20 of joining part 52 is set to have substantially the same dimension as a width W28 of the projecting part 28. In the stator member 1, both end faces 28b of the fixing plate 14 and both sides of the fixing hole 20b of the joining plate 52 are abutted with each other.

In addition, the cut-out part 34 is formed with a recessed part 34a in a concave shape at a position corresponding to the burr 30 of the fixing plate 14 so as to avoid the burr 30 or so as not to abut with the burr 30. As shown in FIG. 2, the burr 30 of the fixing plate 14 is formed so as to protrude in the face direction from edge portions of one face 14b of the fixing plate 14 and thus the recessed parts 34a of the cut-out parts 34 are formed in a concave shape on an inner side of side faces 34b of the cut-out parts 34 so as not to abut with the burr 30.

The cut-out part 34 of the pole-teeth part 26a is fitted to the connecting part 24 from a tip end side of the fixing plate 14 of the connecting part 24 and the pole-teeth parts 26a are integrally assembled into the connecting part 24. As result, the first yoke Y1 is structured in which the fixing plates 14 are standingly formed on both sides of a plurality of the pole teeth 10.

In this embodiment, the recessed part 34a is formed in the cut-out part 34 of the pole-teeth part 26a. Therefore, when the fixing plate 14 is inserted into the cut-out part 34, the burr 30 of the fixing plate 14 does not abut with the edge portion of the cut-out part 34 and thus the fixing plate 14 can be smoothly inserted into and fitted to the cut-out part 34. Accordingly, workability of connecting the pole-teeth part 26a with the connecting part 24 is improved. Further, the fixing plate 14 is not required to be forcibly inserted into the cut-out part 34 and thus a large force is not carelessly applied. Therefore, the first yoke is not deformed and thus reduction of yield can be prevented.

In addition, the recessed part 34a is formed in the cut-out part 34 of the pole-teeth part 26a and thus the width of the cut-out part 34 is not required to be made larger in consideration of the size of the burr 30 of the fixing plate 14. Therefore, a clearance between the outside shape of the fixing plate 14 and a portion of the pole-teeth part 26a except the recessed part 34a of the cut-out part 34 can be set extremely small. Therefore, an abutting part (lowest portion of the fixing plate 14) which abuts with end faces 34b, 34b and 34c of the cut-out part 34 is formed in a portion except the burr 30 of the fixing plate 14. In the stator member 1, both end faces 14a of the fixing plate 14 and both side faces 34b of the cut-out part 34 are abutted with each other. Further, the end face 34c on the inner side of the cut-out part 34 and the one face 14b of the fixing plate 14 are abutted with each other. In this manner, the pole-teeth part 26a is firmly fixed by the connecting part 24 without rattling and thus characteristic of the stator member 1 is stable and reduction of yield can be prevented.

After that, the fixing plates 14 of the first yoke Y1 are inserted into through-holes 16 of the coil bobbins 18 around which the coil 12 is wound and the coils 12 are assembled to the first yoke Y1.

FIG. 3 is an enlarged cross-sectional view showing a state where the fixing plate 14 of the first yoke Y1 has been inserted into the through-hole 16 of the coil bobbin 18. The coil bobbin 18 is formed with flanges 40a and 40b at both ends of a main body formed in a rectangular tubular shape and a terminal block 42 is formed at an outer edge portion of the flange 40a. A coil wire which is made of a copper wire or the like whose surface is coated with insulating layer is wound around the main body 38 of the coil bobbin 18 plural times to structure the coil 12. Both end parts of the coil are bound around a pair of terminals 44 provided in the terminal block 42 and an electric current is supplied to the coil 12 through the terminals 44.

A bipolar drive in which the respective coils 12 are serially-connected with their winding directions are the same and, alternatively, a unipolar drive in which the respective coils 12 are serially-connected but their winding directions are opposite to each other may be applied to power feeding to the coils 12 provided in the stator member 1.

The through-hole 16 into which the fixing plate 14 of the first yoke Y1 is inserted is formed at the center of the coil bobbin 18. The through-hole 16 has substantially the same shape as the cross-sectional shape of the fixing plate 14. As shown in FIG. 2, since the fixing plate 14 is formed in a substantially rectangular cross section, the through-hole 16 is also formed in a substantially rectangular cross section. Further, a length of a short side of the rectangular cross section is set to be substantially the same as the plate thickness T14 of the fixing plate 14 and a length of its long side is set to be substantially the same as the width W14 of the fixing plate 14 and the fixing plate 14 is lightly press-fitted to the through-hole 16.

In addition, the recessed part 16a is formed in a concave-shape at a position corresponding to the burr 30 of the fixing plate 14 for avoiding the burr 30 so that abutting area of the fixing plate 14 with the through-hole 16 is reduced for adjusting a press-fitting pressure to be a desired value. The recessed part 16a is formed in a groove shape, which is recessed in the long side direction, at four corners of inner peripheral faces of the substantially rectangular-shaped cross section of the through-hole 16. As shown in FIG. 2, the burr 30 of the fixing plate 14 is formed only at the edge portions of one face 14b of the fixing plate 14 but the recessed part 16a of the through-hole 16 of the coil bobbin 18 are formed at four corners of the rectangular shape so as to recess in the long side direction. In this manner, since the recessed parts 16a are formed at four corners of the through-hole 16a, even when a direction of the coil bobbin 18 is changed, the recessed part 16a can be disposed at the position corresponding to the burr of the fixing plate 14. Further, even when the burr is formed at edge portions of both faces of the fixing plate 14, the burr can be accommodated in the recessed part 16a. The fixing plate 14 of the first yoke Y1 is inserted into the through-hole 16 of the coil bobbin 18 and the coil 12 is fixed to the first yoke Y1.

In this embodiment, the cross-sectional shape of the fixing plate 14 and the cross-sectional shape of the through-hole 16 of the coil bobbin 18 are formed in substantially the same shape and thus the fixing plate 14 is lightly press-fitted into the through-hole 16 by means of that the fixing plate 14 is pushed into the through-hole 16 with a little force. In this case, the recessed part 16a is formed in the through-hole 16 of the coil bobbin 18 at the position corresponding to the burr 30 of the fixing plate 14. Therefore, the burr 30 of the fixing plate 14 is not caught by an edge of the opening or the inner peripheral face of the through-hole 16 and thus the fixing plate 14 can be inserted into the through-hole 16 smoothly. Further, a size of the recessed part 16a formed at the position corresponding to the burr 30 is set to be a size that the abutting area of the fixing plate 14 with the through-hole 16 is reduced so that the fixing plate 14 is lightly press-fitted to the through-hole 16 with a desired pressing force. Accordingly, the light press fitting can be performed with a high degree of accuracy and assembling workability of the coil bobbin 18 to the first yoke Y1 is improved. Further, the fixing plate 14 is not required to be forcibly inserted into the through-hole 16 and thus a large force is not carelessly applied. Therefore, the first yoke Y1 is prevented from being deformed or the inner peripheral face of the through-hole 16 of the coil bobbin 18 is prevented from being scraped and thus the positional relationship between the pole teeth 10 of the first yoke Y1 and the coil 12 does not displace and reduction of yield can be prevented.

In addition, the recessed part 16a is formed in the through-hole 16 of the coil bobbin 18 at the position corresponding to the burr 30 of the fixing plate 14. Further, the size of the recessed part 16a is set to be a size that the abutting area of the fixing plate 14 with the through-hole 16 is reduced so that the fixing plate 14 is lightly press-fitted to the through-hole 16 with a desired pressing force. In other words, the recessed part 16a is formed larger than the size of the burr 30. Therefore, the entire size of the through-hole 16 is not required to make larger in consideration of the size of the burr 30 of the fixing plate 14. Accordingly, a clearance between the outside shape of the fixing plate 14 and a portion of the through-hole 16 except the recessed part 16a can be set to be extremely small.

As shown in FIG. 3, since the clearance between the outside shape of the fixing plate 14 and the through-hole 16 is set to be extremely small, in the state where the fixing plate 14 is inserted into the through-hole 16, both faces 16b of the long side of the inner peripheral face of the through-hole 16 are abutted with one face 14b and the other face 14c (upper and lower faces in the drawing) of the fixing plate 14 and both faces 16c of the short side of the inner peripheral face of the through-hole 16 are abutted with both end faces 14a (right and left side faces). In this manner, the abutting part 36b abutting with the surface of the fixing plate 14 without a gap is formed on the inner peripheral face of the through-hole 16. Therefore, the coil bobbin 18 is firmly fixed to the fixing plate 14 without rattling. As a result, the characteristic of the stator member 1 becomes stable and reduction of yield can be prevented.

The second yoke Y2 is assembled and fixed to a protruded portion of the fixing plate 14 of the first yoke Y1 which is protruded from the through-hole 16 of the coil bobbin 18.

As shown in FIG. 1, the second yoke Y2 is comprised of a pair of pole-teeth parts 26b which is formed with a plurality of pole teeth 10 standingly formed so as to be adjacently disposed to the pole teeth 10 of the first yoke Y1 and a joining part 52 for fixing the pole-teeth parts 26b of the second yoke Y2 to each other and fixing the second yoke Y2 to the first yoke Y1. Each of a pair of the pole-teeth parts 26b is formed with a fixing hole 20a into which the fixing plate 14 is inserted. The fixing hole 20 of the second yoke Y2 into which the fixing plate 14 of the first yoke Y1 is inserted is comprised of the fixing hole 20a on the pole-teeth part side and the fixing hole 20b on the joining part side. The second yoke Y2 is formed of a magnetic steel plate such as iron which is press-worked.

As shown in FIG. 1, a base portion 32b connecting the respective pole teeth 10 is disposed on a base end side of a plurality of the pole teeth 10 which is adjacently disposed to the pole teeth 10 of the first yoke Y1. The fixing hole 20a is formed in the base portion 32b and an upper end of the fixing plate 14 and the projecting part 28a are inserted into the fixing hole 20a. Therefore, the pole teeth 10 of the second yoke Y2 are adjacently located to the pole teeth 10 of the first yoke Y1 accurately.

The fixing hole 20a of the base portion 32b has substantially the same shape as the cross-sectional shape of the fixing plate 14. As shown in FIG. 2, since the fixing plate 14 is formed in a substantially rectangular cross section, the fixing hole 20a is also formed in a substantially rectangular cross section. Further, a length of a short side of the rectangular cross section is set to be substantially the same as the plate thickness T14 of the fixing plate 14 and a length of its long side is set to be substantially the same as the width W14 of the fixing plate 14.

In addition, similarly to the coil bobbin 18, a recessed part 20a-a is formed in a concave shape at a position corresponding to the burr 30 of the fixing plate 14 for avoiding the burr 30 so that abutting area of the fixing plate 14 with the fixing hole 20a is reduced for adjusting a press-fitting pressure to be a desired value. The burr 30 of the fixing plate 14 is laterally protruded from the edge portion of the one face 14b of the fixing plate 14 but the recessed part 20a-a of the fixing hole 20a is formed at four corners of the rectangular shape so as to recess in the long side direction. In this manner, since the recessed parts 20a-a are formed at four corners of the fixing hole 20a, even when the burr is formed at edge portions of the other face or both faces of the fixing plate 14, the burr can be accommodated in the recessed part 16a.

As shown in FIG. 4, the upper end of the fixing plate 14 and the projecting part 28 of the fixing plate 14 of the first yoke Y1 are inserted into the fixing hole 20a formed in the pole-teeth part 26b of the second yoke Y2 to position the pole-teeth part 26b of the second yoke Y2 to the first yoke Y1. In this embodiment, the cross-sectional shape of the fixing plate 14 and the cross-sectional shape of the fixing hole 20a are formed in substantially the same shape and thus the fixing plate 14 is pushed into the fixing hole 20a with a little force and, as a result, the fixing plate 14 is lightly press-fitted into the fixing hole 20a. In this case, the recessed part 20a-a is formed in the fixing hole 20a at the position corresponding to the burr 30 of the fixing plate 14. Therefore, the burr 30 of the fixing plate 14 is not caught by an edge of the opening or the inner peripheral face of the fixing hole 20a and thus the fixing plate 14 can be inserted into the fixing hole 20a smoothly. Further, the size of the recessed part 20a-a is set to be a size that the abutting area of the fixing plate 14 with the fixing hole 20a is reduced so that the fixing plate 14 is lightly press-fitted to the fixing hole 20a with a desired pressing force. Therefore, the light press fitting can be performed with a high degree of accuracy and assembling workability of the pole-teeth part 26b of the second yoke Y2 to the first yoke Y1 is improved. Further, the fixing plate 14 is not required to be forcibly inserted into the fixing hole 20a and thus a large force is not required to be carelessly applied. Therefore, the pole-teeth parts 26a and/or 26b of the first yoke Y1 and/or the second yoke Y2 are prevented from being deformed and thus the positional relationship between the pole teeth 10 of the first yoke Y1 and the pole teeth 10 of the second yoke Y2 does not displace and reduction of yield can be prevented.

In addition, the recessed part 20a-a is formed on the fixing hole 20a at the position corresponding to the burr 30 of the fixing plate 14. Further, the size of the recessed part 20a-a is set to be a size that the abutting area of the fixing plate 14 with the fixing hole 20a is reduced so that the fixing plate 14 is lightly press-fitted to the fixing hole 20a with a desired pressing force. In other words, the recessed part 20a-a is formed larger than the size of the burr 30. Therefore, the entire size of the fixing hole 20a is not required to be made larger in consideration of the size of the burr 30 of the fixing plate 14. Accordingly, a clearance between the outside shape of the fixing plate 14 and a portion of the fixing hole 20a except the recessed part 20a-a can be set extremely small.

FIG. 5 is a top plan view showing a state where the fixing plate 14 has been inserted into the fixing hole 20a of the pole-teeth part 26b. As described above, since the clearance between the outside shape of the fixing plate 14 and the fixing hole 20a is set to be extremely small, both faces of the long side of the inner peripheral face of the fixing hole 20a are abutted with the one face 14b and the other face 14c (upper and lower faces in the drawing) of the fixing plate 14 and both faces of the short side of the inner peripheral face of the fixing hole 20a are abutted with both end faces 14a (right and left side faces). In this manner, the abutting part 36c which abuts with the surface of the fixing plate 14 without a gap is formed on the inner peripheral face of the fixing hole 20a. Therefore, the pole-teeth part 26b of the second yoke Y2 is accurately positioned and firmly fixed to the fixing plate 14 without rattling. As a result, the characteristic of the stator member 1 becomes stable and reduction of yield can be prevented.

As shown in FIG. 6, the joining part 52 for fixing the pole-teeth parts 26b of the second yoke Y2 to each other and for fixing the second yoke Y2 to the first yoke Y1 is fixed to the projecting parts 28 which are formed at the tip end of the fixing plates 14 of the first yoke Y1.

The joining part 52 is a plate member which is formed at its center with an opening 54 for shaft through which the rotor shaft RS is passed. The joining part 52 is formed with fixing holes 20b into which the projecting part 28 provided at the tip end of the fixing plate 14 is inserted on both sides of the hole 54 for shaft so as to penetrate from one face to the other face of the joining part 52.

Further, as shown in FIG. 6 and FIG. 8, the recessed part 20b-a is formed in the fixing hole 20b of the joining part 52 at the position corresponding to the burr 30a of the fixing plate 14. Further, similarly to the above-mentioned recessed part 20a-a, the size of the recessed part 20b-a is set to be a size that the abutting area of the fixing plate 14 with the fixing hole 20b is reduced so that the fixing plate 14 is lightly press-fitted to the fixing hole 20b with a desired pressing force. Joining part 52 rests on the end face 14d of the fixing plate 14. In other words, the recessed part 20b-a is formed larger than the size of the burr 30a and thus the entire size of the fixing hole 20b is not required to be made larger in consideration of the size of the burr 30a of the fixing plate 14.

As described above, a portion of the inner peripheral face of the fixing hole 20b except the recessed part 20b-a is abutted with the surface of the projecting part 28. Therefore, when a gap space of the recessed part 20b-a is filled up with a melted tip end of the projecting part 28, the contacting area of the surface of the projecting part 28 with the inner peripheral face of the fixing hole 20b of the joining part 52 can be increased and thus the joining part 52 can be firmly fixed to the tip end of the fixing plate 14 of the first yoke Y1.

An outer peripheral end face of the joining part 52 is formed so as to be substantially the same size as outer peripheral end faces of the base portions 32b of the pole-teeth parts 26b in the state that the projecting parts 28 are inserted into the fixing hole 20b of the joining part 52. The outer peripheral end face of the joining part 52 is spot-welded at several points with the outer peripheral end faces of the pole-teeth parts 26b and thus a pair of the pole-teeth parts 26b are fixed to each other to structure the second yoke Y2.

In this manner, the connecting part 24 and the fixing plate 14 of the first yoke Y1 are fixed to each other and the first yoke Y1 and the second yoke Y2 are accurately positioned and fixed to each other.

Next, modified examples of the shape of the through-hole which is provided in the coil bobbin and/or the shape of the fixing hole provided in the second yoke Y2 will be described below. For example, as shown in FIG. 7(a), a recessed part 16-1a and/or a recessed part 20-1a in a circular recessed shape may be formed at corner parts of a through-hole 16-1 and/or a fixing hole 20-1 which are formed in a rectangular shape. Further, when a burr 30-1 of the fixing plate 14-1 and/or the projecting part formed at its tip end is formed in a plate thickness direction of the fixing plate 14-1, as shown in FIG. 7(b), a recessed part 16-2a and/or a recessed part 20-2a may be formed in a concave shape in a short side direction of a through-hole 16-2 and/or a fixing hole 20-2. Further, as shown in FIG. 7(c), widths of a recessed part 16-3a and/or a recessed part 20-3a which are formed in a concave shape on an inner peripheral face of a through-hole 16-3 and/or a fixing hole 20-3 may be set larger than a size of a burr of the fixing plate 14-1. In this manner, when the widths of the recessed part 16-3a and/or the recessed part 20-3a are changed, an area of an abutting part 36-3 can be changed where a surface of the fixing plate 14-1 and inner peripheral faces of the through-hole 16-3 and/or the fixing hole 20-3 are abutted with each other at the time when the fixing plate 14-1 is inserted into the through-hole 16-3 and/or the fixing hole 20-3. When the width of the recessed part 16-3a and/or the recessed part 20-3a is set to be smaller, an area of the abutting part 36-3 becomes larger. On the contrary, when the width of the recessed part 16-3a and/or the recessed part 20-3a is set to be larger, an area of the abutting part 36-3 becomes smaller. In this manner, a force for press-fitting the fixing plate 14-1 into the through-hole 16-3 and/or the fixing hole 20-3 can be controlled.

Next, a motor 2 in accordance with an embodiment of the present invention will be described below. FIG. 9 is an exploded perspective view showing a structure of the motor 2 in accordance with an embodiment of the present invention. FIG. 10 is a perspective view showing a state where the motor 2 shown in FIG. 9 has been assembled.

The motor 2 is provided with a stator S which is structured of two stator members 1 that are superposed on each other. As shown in FIG. 9, the stator S is structured such that respective first yokes Y1 of the stator members 1 are disposed to be superposed on each other in a back to back manner and the respective terminal blocks 42 provided in the coil bobbins 18 of the stator members 1 are structured so as to be superposed on each other. In these stator members 1, the end faces of the first yoke Y1 are welded and fixed to each other so that the pole teeth 10 of the respective stator members 1 are disposed in a coaxial manner.

The rotor having a rotor shaft to which rotor magnets are attached is disposed on an inner side of the stator to structure the motor. As shown in FIG. 9, the rotor is provided with rotor magnets corresponding to the respective stator members and the rotor magnets are fixed on the outer periphery of the rotor shaft. Both ends of the rotor shaft are rotatably supported with thrust-bearings.

In the motor 2 provided with the stator S which is structured as described above, when an electric current is supplied to the coil 12 that is wound around the coil bobbin 18, interaction of a magnetic field with the rotor magnet M is generated and thus a rotational driving force is applied to the rotor R and rotation is outputted on a front end side of the rotor shaft RS.

A shaft end 60a on a base end side (opposite-to-output side) of the rotor shaft RS is supported through a bearing body 62a. The rotor shaft RS is supported through a steel ball 64a and the steel ball 64a is held by a concaved conical face (not shown) which is formed on the shaft end 60a of the rotor shaft RS and a concaved conical face 66a which is formed on the bearing body 62a. A plate-shaped bearing holder 68a made of a metal sintered body or the like is disposed on an opposite-to-output side end part (under side face in the drawing) of the stator S. The bearing body 62a is mounted on a through hole 70 for bearing body of the bearing holder 68a. A pressurization member 72 made of a metal plate is disposed on a further opposite-to-output side of the bearing holder 68a. The pressurization member 72 is fixed to the bearing holder 68a by means of that six pawl parts 74 extended to the bearing holder 68a side from its outer peripheral edge part of the pressurization member 72 are engaged with an outer peripheral edge part 68b of the bearing holder 68a. A plate spring part 76 is cut and bent to the bearing side from the pressurization member 72. The plate spring part 76 urges the bearing body 62a which is mounted on the through hole 70 for bearing body toward the rotor shaft RS and applies a pressure to the rotor shaft RS to move its tip end side.

A shaft end 60b on a tip end side (output side) of the rotor shaft RS is structured similarly to the shaft end 60a on the base end side (opposite-to-output side) of the rotor shaft RS. A steel ball 64b with which a concaved conical face 78 formed on the shaft end 60b of the rotor shaft RS is abutted and a bearing body 62b accommodating the steel ball 64b are provided. The bearing body 62b is provided with a flange 82 larger than an inner diameter dimension of a mounting aperture 80 of the frame 78 and thus, when attached to the frame 78, the bearing body 62b is not detached in the axial direction.

A screw groove 84 is helically formed on the surface of a lead screw part 82 of the rotor shaft RS which is protruded from the stator S. The lead screw part 82 moves a slider (not shown) engaging with the screw groove 84 in the axial direction in a parallel manner with rotation of the rotor shaft RS. A moving direction of the slider is controlled by changing a direction of rotation of the rotor shaft RS.

The frame 78 is attached to the stator S by means of that its mounting part 86 is superposed on and joined to the upper face of the stator S. A hole 88 for shaft into which the rotor shaft RS is inserted is formed at the center of the mounting part 86 and cut-out parts 90 for projecting part are formed on its both sides.

An outer end face of the mounting part 86 of the frame 78 and an outer end face of the second yoke Y2 of the stator member 1 on the output side of the stator S are located on substantially the same size. The end faces of the mounting part 86 and the second yoke Y2 are joined to each other by spot welding or the like and the frame 78 is fixed to the stator S. As a result, the rotor magnets M attached to the rotor shaft RS are disposed in the inner side of the stator S.

According to the stator member 1 provided in the motor 2, the recessed parts 16a, 20a-a and 20b-a are formed on the through-hole 16 of the coil bobbin 18 and the fixing hole 20 (20a, 20b) of the second yoke Y2 at the positions corresponding to the burr 30 of the fixing plate 14 and the burr 30a of the projecting part 28 of the first yoke Y1. Therefore, when the fixing plate 14 is to be inserted into the through-hole 16 and the fixing hole 20, the burrs 30 and 30a of the fixing plate 14 and the projecting part 28 are not caught by the opening edge portions and the inner peripheral faces of the through-hole 16 and the fixing hole 20. Therefore, the fixing plate 14 can be smoothly inserted into the through-hole 16 and the fixing hole 20 and thus assembling workability of the stator member 1 and the motor 2 are improved. Further, the fixing plate 14 is not required to be forcibly inserted into the through-hole 16 and the fixing hole 20 and thus a large force is not carelessly applied. Therefore, reduction of yield of the stator member 1 and the motor 2 can be prevented.

Further, the burr 30 of the fixing plate 14 is formed so as to protrude from the end face 14a and the recessed parts 16a, 20a-a and 20b-a are formed on the inner peripheral faces of the through-hole 16 and the fixing hole 20 in a concaved shape so as to avoid the burrs 30 and 30a of the fixing plate 14. Therefore, when the fixing plate 14 is to be inserted into the through-hole 16 and the fixing hole 20, the burrs of the fixing plate are not caught by the opening edge portions and the inner peripheral faces of the through-hole 16 and the fixing hole 20 effectively.

When the cross-sectional shape of the fixing plate 14 is rectangular, the burr 30 may be often formed at a corner part. Therefore, the through-hole 16 and the fixing hole 20 are formed in a rectangular shape and the recessed parts 16a, 20a-a and 20b-a are formed at the corner part of the rectangular shape, the burr 30 of the fixing plate 14 can be effectively avoided on the edge portions and the inner peripheral faces of the through-hole 16 and the fixing hole 20.

More specifically, when the cross-sectional shape of the fixing plate 14 is rectangular and the burr 30 is formed in its long side direction, the shape of the through-hole 16 and the fixing hole 20 are rectangular and the recessed parts 16a, 20a-a and 20b-a are formed in the longitudinal direction of the rectangle. In this case, the yoke is often formed to be push out in the longitudinal direction from the die at the time of forming the yoke. When the yoke is formed as described above, plastic deformation at the time of forming the yoke can be prevented. However, in the forming method described above, the burr 30 is often formed in the longitudinal direction and thus the burr of the fixing plate can be effectively avoided on the opening edge portions and the inner peripheral faces of the through-hole 16 and the fixing hole 20.

Further, portions of the inner peripheral faces of the through-hole 16 and the fixing hole 20 except the recessed parts 16a, 20a-a and 20b-a are formed with abutting parts 36a, 36b, 36c and 36d which are respectively abutted with four faces of the fixing plate 14. Therefore, the through-hole 16 and the fixing hole 20 are fixed to the fixing plate 14 by the abutting parts 36a, 36b, 36c and 36d, i.e., the four abutting faces without displacement. Accordingly, the coil bobbin 18 and the second yoke Y2 are firmly fixed to the first yoke Y1 without rattling.

In this embodiment, the fixing plate 14 is inserted into the through-hole 16 and the fixing hole 20 by press fitting. However, a force required to press-fit the fixing plate 14 to the through-hole 16 and the fixing hole 20, in other words, a press fitting force when the fixing plate 14 is inserted into the through-hole 16 and the fixing hole 20 is adjusted in a desired value by setting sizes of the recessed parts 16a, 20a-a and 20b-a formed on the inner peripheral faces of the through-hole 16 and the fixing hole 20 properly. Therefore, plastic deformation due to a load by press fitting of the fixing plate 14 and the second yoke Y2 can be prevented. Further, the through-hole 16 of the coil bobbin 18 and the fixing hole 20 of the second yoke Y2 can be fixed to the fixing plate 14 of the first yoke Y1 without rattling and thus yield can be improved.

When the motor 2 is structured so that the rotor R whose rotor shaft RS is attached with the rotor magnets M is disposed on the inner side of the stator member 1 having the structure as described above, the similar effects as those of the stator member 1 can be obtained and thus assembling workability of the motor 2 is improved and reduction of yield can be prevented.

Although the present invention has been shown and described with reference to specific embodiments, various changes and modifications will be apparent to those skilled in the art from the teachings herein. For example, forming of the recessed part is not limited to the second yoke and the coil bobbin. Among other various kinds of member attached to a stepping motor, in a case that one member is inserted into and fixed to another member, the recessed part may be formed on a hole to be inserted. Further, the present invention is not limited to a stepping motor. For example, like a brushless motor, when a projecting part disposed on a circumferential face of a cylindrical stator core is inserted into a mounting hole formed at a center of the coil bobbin and a plurality of the coils is disposed on the circumferential face of the stator core, a recessed part may be formed on the mounting hole of the coil bobbin for avoiding a burr of the projecting part of the stator core.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A stator member comprising:
a coil bobbin which is provided with a through-hole and around which a coil is wound; and
a yoke which is provided with a fixing part that is inserted into the through-hole of the coil bobbin;
wherein the through-hole of the coil bobbin is provided with at least a recessed part at a position corresponding to a burr of the fixing part of the yoke.

2. The stator member according to claim 1, wherein the recessed part is formed on an inner peripheral face of the through-hole in a concave shape so as to avoid the burr of the fixing part.

3. The stator member according to claim 1, wherein the through-hole is formed in a quadrangular shape and the recessed part is formed at a corner part of the quadrangular shape.

4. The stator member according to claim 3, wherein the through-hole is formed in a rectangular shape and the recessed part is formed in a longitudinal direction of the rectangular shape.

5. The stator member according to claim 3, wherein an inner peripheral face of the through-hole is formed with abutting parts which abut with a surface of the fixing part in all directions corresponding to the quadrangular shape.

6. The stator member according to claim 1, wherein the fixing part is inserted into the through-hole by press fitting.

7. The stator member according to claim 6, wherein the through-hole is formed in a quadrangular shape and the recessed part is formed at a corner part of the quadrangular shape, and an abutting area when the fixing part of the yoke is inserted into the through-hole is reduced by the recessed part.

8. The stator member according to claim 7, wherein
an inner peripheral face of the through-hole is formed with abutting parts which abut with a surface of the fixing part in all directions corresponding to the quadrangular shape, and
a press fitting force is adjusted by the recessed part when the fixing part of the yoke is to be inserted into the through-hole.

9. A stator member comprising:
a first yoke which is provided with a fixing plate at a side end portion of the first yoke; and
a second yoke which is provided with a fixing hole into which the fixing plate is inserted;
wherein the first yoke and the second yoke are disposed to face each other and a recessed part is formed on the fixing hole of the second yoke at a position corresponding to a burr formed on the fixing plate.

10. The stator member according to claim 9, wherein the recessed part is formed on an inner peripheral face of the fixing hole in a concave shape so as to avoid the burr formed on the fixing plate.

11. The stator member according to claim 9, wherein the fixing hole is formed in a quadrangular shape and the recessed part is formed at a corner part of a rectangular shape.

12. The stator member according to claim 11, wherein the fixing hole is formed in the rectangular shape and the recessed part is formed in a longitudinal direction of the rectangular shape.

13. The stator member according to claim 11, wherein an inner peripheral face of the fixing hole is formed with abutting parts which abut with a surface of the fixing plate in all directions corresponding to the quadrangular shape.

14. The stator member according to claim 9, wherein the fixing plate is inserted into the fixing hole by press fitting.

15. The stator member according to claim 14, wherein the fixing hole is formed in a quadrangular shape and the recessed part is formed at a corner part of a rectangular shape, and an abutting area when the fixing plate is to be inserted into the fixing hole is reduced by the recessed part.

16. The stator member according to claim 15, wherein
an inner peripheral face of the fixing hole is formed with abutting parts which abut with a surface of the fixing plate in all directions corresponding to the quadrangular shape, and
a press fitting force is adjusted by a size of the recessed part when the fixing plate is to be inserted into the fixing hole.

17. The stator member according to claim 9, further comprising
a coil bobbin which is provided with a through-hole into which the fixing plate is inserted; and
a recessed part which is formed on the through-hole of the coil bobbin at a position corresponding to a burr formed on the fixing plate.

18. A motor comprising:
a rotor magnet which is attached to a rotor shaft; and
a stator member which is disposed on an outer side of the rotor magnet comprising:
a coil bobbin which is provided with a through-hole and around which a coil is wound; and
a yoke which is provided with a fixing part that is inserted into the through-hole of the coil bobbin;
wherein the through-hole of the coil bobbin is provided with at least a recessed part at a position corresponding to a burr of the fixing part of the yoke.

19. The motor according to claim 18, wherein the recessed part is formed on an inner peripheral face of the through-hole in a concave shape so as to avoid the burr formed on the fixing part.

20. The motor according to claim 18, wherein the fixing part is inserted into the through-hole by press fitting.

21. A motor comprising.
a rotor magnet which is attached to a rotor shaft; and
a stator member which is disposed on an outer side of the rotor magnet comprising:
a first yoke which is provided with a fixing plate at a side end portion of the first yoke; and
a second yoke which is provided with a fixing hole into which the fixing plate is inserted;
wherein the first yoke and the second yoke are disposed to face each other and a recessed part is formed on the fixing hole of the second yoke at a position corresponding to a burr formed on the fixing plate.

22. The motor according to claim 21, wherein the recessed part is formed on an inner peripheral face of the fixing hole in a concave shape so as to avoid the burr formed on the fixing plate.

23. The stator member according to claim 21, wherein the fixing plate is inserted into the fixing hole by press fitting.

24. The stator member according to claim 21, wherein the stator member further comprises:
a coil bobbin which is provided with a through-hole into which the fixing plate is inserted; and
a recessed part which is formed on the through-hole of the coil bobbin at a position corresponding to a burr formed on the fixing plate.
